(19) United States
(12) Patent Application Publication
(10) Pub. No.: US 2026/0146683 A1
(43) Pub. Date: May 28, 2026

(54) SLIT VALVE APPARATUS

(71) Applicant: Samsung Electronics Co., Ltd., Suwon-si (KR)

(72) Inventors: Woomin Jung, Suwon-si (KR); Sunghyup Kim, Suwon-si (KR); Sanghoon Lee, Suwon-si (KR)

(21) Appl. No.: 19/305,451

(22) Filed: Aug. 20, 2025

(30) Foreign Application Priority Data
Nov. 26, 2024 (KR) 10-2024-0171470

(51) Int. Cl. F16K 51/02; F16K 3/02

(52) U.S. Cl. CPC F16K 51/02; F16K 3/0209; F16K 3/0254

(57) ABSTRACT

A slit valve apparatus includes a housing between respective transfer ports of a transfer chamber and a processing chamber, first and second passages each extending from an outer surface to an inner surface of a sidewall of the housing, a slit door arranged to be movable between a chamber open position and a chamber sealing position, a slit door actuator configured to drive the slit door in a vertical direction and a horizontal direction, a slit sensor configured to sense vibration of the housing, and a controller configured to control the slit door actuator, wherein the controller is further configured to, in a k-th period (where k is a natural number of 2 or more), identify a k+1-th displacement profile based on a k-th parameter, and in a k+1-th period, control the slit door actuator to drive the slit door by the k+1-th displacement profile.

### CROSS-REFERENCE TO RELATED APPLICATION(S)

This application is based on and claims priority under 35 U.S.C. § 119 to Korean Patent Application No. 10-2024-0171470, filed on Nov. 26, 2024, in the Korean Intellectual Property Office, the disclosure of which is incorporated by reference herein in its entirety.

### BACKGROUND

The insides of processing chambers, in which semiconductor processes are performed, may need to be maintained in vacuum states. However, when substrates are transferred from transfer chambers to processing chambers, transfer ports of the processing chambers are opened, and air may flow into the processing chambers. When large amounts of air flow into processing chambers, it may require significant time and resources to make the insides of the processing chambers in vacuum states again. Therefore, transfer ports may need to be opened and then closed as quickly as possible.

### SUMMARY

Slit valve apparatuses may quickly open or close transfer ports of processing chambers by driving slit doors. However, driving of slit doors may generate a significant shock or jolt to processing chambers. The present disclosure provides a slit valve apparatus capable of reducing a shock to a processing chamber by driving a slit door.

However, the present disclosure is not limited to the above aspect, and the above and other aspects of the present disclosure will be clearly understood by those of ordinary skill in the art from the following description.

According to an aspect of the present disclosure, a slit valve apparatus includes a housing between respective transfer ports of a transfer chamber and a processing chamber, two passages, which are arranged at positions respectively corresponding to positions of the respective transfer ports of the transfer chamber and the processing chamber and each extend from an outer surface to an inner surface of a sidewall of the housing, a slit door arranged in the housing to be movable between a chamber open position and a chamber sealing position, a slit door actuator configured to drive the slit door in a vertical direction and a first horizontal direction, a slit sensor arranged to be connected to the housing and configured to sense vibration of the housing, and a controller configured to control the slit door actuator, wherein the controller is further configured to, in a k-th period (where k is a natural number of 2 or more), obtain a slit vibration value from the slit sensor, identify a k+1-th displacement profile based on the slit vibration value and a k-th parameter, and in a k+1-th period, control the slit door actuator to drive the slit door by the k+1-th displacement profile, the chamber open position is a position of the slit door to cause the two passages to be opened, the chamber sealing position is a position of the slit door to cause the two passages to be closed, the first horizontal direction is a horizontal direction from a center of the slit door toward the two passages, and the k-th parameter includes a plurality of parameters used for a control operation for receiving the slit vibration value in the k-th period and outputting the k+1-th displacement profile.

According to another aspect of the present disclosure, a slit valve apparatus includes a housing between respective transfer ports of a transfer chamber and a processing chamber, two passages, which are arranged at positions respectively corresponding to positions of the respective transfer ports of the transfer chamber and the processing chamber and each extend from an outer surface to an inner surface of a sidewall of the housing, a sealing plate between the two passages, a horizontal actuator configured to drive the sealing plate in a first horizontal direction between an expansion position and a contraction position, a slit sensor arranged to be connected to the housing and configured to sense vibration of the housing, and a controller configured to control the horizontal actuator, wherein the controller is further configured to, in a k-th period (where k is a natural number of 2 or more), obtain a slit vibration value from the slit sensor, identify a k+1-th displacement profile based on the slit vibration value and a k-th parameter, and in a k+1-th period, control the horizontal actuator to drive the sealing plate by the k+1-th displacement profile, the expansion position is a position of the sealing plate to cause the two passages to be closed, the contraction position is a position of the sealing plate to cause the two passages to be opened, and the k-th parameter includes a plurality of parameters used for a control operation for receiving the slit vibration value in the k-th period as an input and outputting the k+1-th displacement profile.

According to another aspect of the present disclosure, a slit valve apparatus includes a housing between respective transfer ports of a transfer chamber and a processing chamber, two passages respectively connected to the respective transfer ports of the transfer chamber and the processing chamber and each extending from an outer surface to an inner surface of a sidewall of the housing, a slit door arranged in the housing to be movable between a chamber open position and a chamber sealing position, a slit door actuator configured to drive the slit door in a vertical direction and a first horizontal direction, a slit sensor arranged to be connected to the housing and configured to sense vibration of the housing, a chamber sensor arranged to be connected to the processing chamber and configured to sense vibration of the processing chamber, and a controller configured to control the slit door actuator, wherein the controller is further configured to, in a k-th period (where k is a natural number of 2 or more), obtain a slit vibration value from the slit sensor and obtain a chamber vibration value from the chamber sensor, identify a k-th parameter based on the chamber vibration value and a target vibration value, identify a k+1-th displacement profile based on the slit vibration value and the k-th parameter, and in a k+1-th period, control the slit door actuator to drive the slit door by the k+1-th displacement profile, the k-th parameter includes a plurality of parameters used for a control operation for receiving the slit vibration value in the k-th period as an input and outputting the k+1-th displacement profile, the chamber open position is a position of the slit door to cause the two passages to be opened, the chamber sealing position is a position of the slit door to cause the two passages to be closed, and the target vibration value is determined based on characteristics of the processing chamber.

### BRIEF DESCRIPTION OF THE DRAWINGS

Implementations will be more clearly understood from the following detailed description taken in conjunction with the accompanying drawings in which:

FIG. 1 is a cross-sectional view of a slit valve apparatus according to an implementation;

FIG. 2 is a cross-sectional view of a slit valve apparatus according to an implementation;

FIG. 3 is a flowchart illustrating a method of driving a slit door of a slit valve apparatus, according to an implementation;

FIG. 4 is a graph schematically illustrating a horizontal-direction displacement profile of a scaling plate, according to an implementation;

FIG. 5 is a graph schematically illustrating a vertical-direction displacement profile of a slit door, according to an implementation;

FIG. 6 is a graph schematically illustrating chamber vibration values according to the driving of a slit door according to an implementation;

FIG. 7 is a block diagram schematically illustrating a configuration of a slit valve apparatus according to an implementation;

FIG. 8 is a block diagram schematically illustrating operations of a slit valve apparatus according to an implementation; and

FIG. 9 is a conceptual diagram illustrating an artificial neural network model according to an implementation.

### DETAILED DESCRIPTION

Hereinafter, implementations of the present disclosure will be described in detail with reference to the accompanying drawings. Like components are denoted by like reference numerals throughout the specification, and repeated descriptions thereof are omitted.

Herein, a horizontal direction may include a first horizontal direction (an X direction) and/or a second horizontal direction (a Y direction). A direction intersecting with the first horizontal direction (the X direction) and the second horizontal direction (the Y direction) may refer to a vertical direction (a Z direction). Herein, a vertical level may refer to a height level of an arbitrary component in the vertical direction (the Z direction).

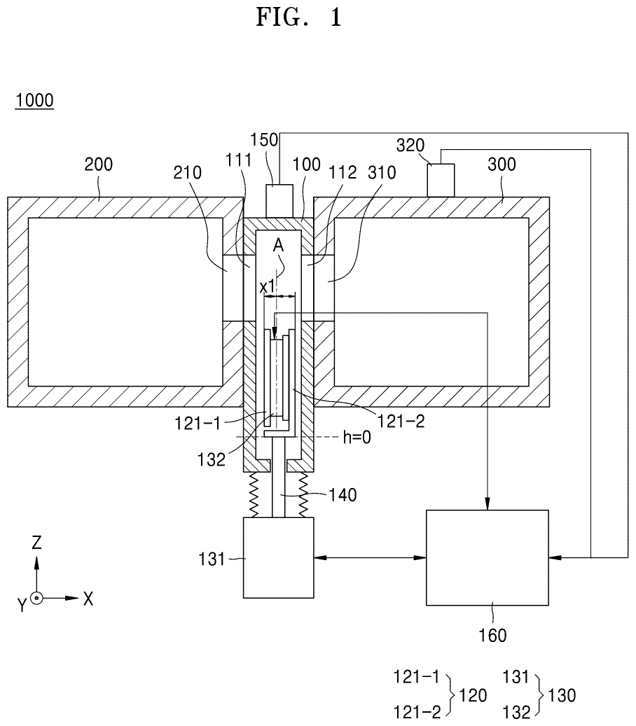

FIG. 1 is a cross-sectional view of a slit valve apparatus 1000 according to an implementation.

Referring to FIG. 1, the slit valve apparatus 1000 may include a housing 100, a slit door 120, a slit door actuator 130, a rod 140, a slit sensor 150, and a controller 160.

The housing 100 may be arranged between a transfer chamber 200 and a processing chamber 300. The housing 100 may have a certain inner space. In the inner space of the housing 100, the slit door 120 and the rod 140 may each be arranged to be movable.

Specifically, the housing 100 may be arranged between a first transfer port 210 of the transfer chamber 200 and a second transfer port 310 of the processing chamber 300. The housing 100 may be connected and coupled to a first sidewall of the transfer chamber 200 and may be connected and coupled to a second sidewall of the processing chamber 300. Here, the first sidewall of the transfer chamber 200 may refer to a sidewall in which the first transfer port 210 is formed, among sidewalls of the transfer chamber 200. In addition, the second sidewall of the processing chamber 300 may refer to a sidewall in which the second transfer port 310 is formed, among sidewalls of the processing chamber 300.

The housing 100 may include a first passage 111 and a second passage 112. The first passage 111 and the second passage 112 may each be formed to extend from an outer surface to an inner surface of a sidewall of the housing 100. The first passage 111 may be arranged at a position corresponding to the position of the first transfer port 210, and the second passage 112 may be arranged at a position corresponding to the position of the second transfer port 310. Specifically, as shown in FIG. 1, the first passage 111 may be arranged at the same vertical level as that of the first transfer port 210 and may be connected to the first transfer port 210 to form a movement path through which a substrate is able to move from the inside of the transfer chamber 200 toward the inside of the housing 100. In addition, the second passage 112 may be arranged at the same vertical level as that of the second transfer port 310 and may be connected to the second transfer port 310 to form a movement path through which a substrate is able to move from the inside of the housing 100 toward the inside of the processing chamber 300.

The slit door 120 may be arranged in the inner space of the housing 100 to be movable in the vertical direction (the Z direction) and the first horizontal direction (the X direction). The slit door 120 may move in the vertical direction (the Z direction) and the first horizontal direction (the X direction) in the inner space of the housing 100 and may open or close the first passage 111 and the second passage 112.

The slit door 120 may include a first sealing plate 121-1 and a second sealing plate 121-2. Here, the first sealing plate 121-1 may move toward the first passage 111 to close the first passage 111, and the second sealing plate 121-2 may move toward the second passage 112 to close the second passage 112.

Specifically, an O-ring may be arranged on each of a first surface of the first sealing plate 121-1 and a second surface of the second sealing plate 121-2. Here, the first surface of the first sealing plate 121-1 is a surface thereof facing the first passage 111, and the second surface of the second sealing plate 121-2 is a surface thereof facing the second passage 112. The O-ring may cause each of the first surface of the first sealing plate 121-1 and the second surface of the second sealing plate 121-2 to be tightly pressed against an inner wall of the housing 100. Because each of the first surface of the first sealing plate 121-1 and the second surface of the second sealing plate 121-2 is tightly pressed against the inner wall of the housing 100, the first passage 111 and the second passage 112 may each be sealed.

As shown in FIG. 1, the first sealing plate 121-1 and the second sealing plate 121-2 may each be arranged parallel to the sidewall of the housing 100. The second sealing plate 121-2 may further include a base arranged in a direction perpendicular to the sidewall of the housing 100. The base of the second sealing plate 121-2 may be coupled with the rod 140. As the base of the second scaling plate 121-2 is coupled with the rod 140, the slit door 120 may receive driving force in the vertical direction from a vertical actuator 131. In addition, the first sealing plate 121-1 and the second sealing plate 121-2 may be coupled to each other by a horizontal actuator 132 that is arranged between the first sealing plate 121-1 and the second sealing plate 121-2.

The slit door actuator 130 may drive the slit door 120 in the vertical direction and the first horizontal direction. The slit door actuator 130 may include the vertical actuator 131 for driving the slit door 120 in the vertical direction and the horizontal actuator 132 for driving the slit door 120 in the first horizontal direction.

Specifically, the vertical actuator 131 may be connected to the slit door 120 via the rod 140 and may provide vertical-direction driving force to the slit door 120 via the rod 140. The slit door 120 may move in the vertical direction in the inner space of the housing 100 based on the provided vertical-direction driving force.

In addition, the horizontal actuator 132 may expand each of the first sealing plate 121-1 and the second sealing plate 121-2 toward the sidewall of the housing 100 or may contract each of the first sealing plate 121-1 and the second sealing plate 121-2 toward a central axis A of the housing 100. In other words, the horizontal actuator 132 may provide first-horizontal-direction driving force allowing each of the first sealing plate 121-1 and the second sealing plate 121-2 to move in the first horizontal direction.

Here, each of the vertical actuator 131 and the horizontal actuator 132 may include a pneumatic actuator or a hydraulic actuator, which generates mechanical power based on a pressure of a fluid. However, each of the vertical actuator 131 and the horizontal actuator 132 is not limited to the examples set forth above and may be implemented by various actuators capable of providing, to the slit door 120, driving force in the vertical direction and the horizontal direction.

The slit sensor 150 may be arranged to be connected to the housing 100 and may sense vibration of the housing 100. In addition, a chamber sensor 320 may be arranged to be connected to a chamber housing of the processing chamber 300 and may sense vibration of the processing chamber 300. Each of the slit sensor 150 and the chamber sensor 320 may include at least one of an acceleration sensor, an angular velocity sensor, a velocity sensor, and a displacement sensor.

For example, when each of the slit sensor 150 and the chamber sensor 320 includes an acceleration sensor, a vibration acceleration of the housing 100 and a vibration acceleration of the chamber housing of the processing chamber 300 may be sensed.

Although FIG. 1 illustrates that the slit sensor 150 is coupled to the upper surface of the housing 100 and the chamber sensor 320 is coupled to the upper surface of the processing chamber 300, this is only an example. The slit sensor 150 may be arranged at various positions allowing the vibration of the housing 100 to be sensed, and the chamber sensor 320 may also be arranged at various positions allowing the vibration of the processing chamber 300 to be sensed.

The controller 160 may be operationally connected to the slit door actuator 130 and may control all operations of the slit valve apparatus 1000.

The controller 160 may be implemented by hardware, firmware, software, or a combination thereof. For example, the controller 160 may include a computing device, such as a workstation computer, a desktop computer, a laptop computer, or a tablet computer. The controller 160 may include a simple controller, a complex processor such as a microprocessor, a central processing unit (CPU), or a graphics processing unit (GPU), a processor configured by software, dedicated hardware, or firmware. The controller 160 may be implemented by, for example, a general-purpose computer, or application-specific hardware, such as a digital signal processor (DSP), a field-programmable gate array (FPGA), or an application-specific integrated circuit (ASIC). The controller 160 may be implemented by instructions that are stored on a machine-readable medium and capable of being read and executed by one or more processors. Here, the machine-readable medium may include any mechanism for storing and/or transmitting information in a form readable by a machine (for example, a computing device). For example, the machine-readable medium may include read-only memory (ROM), random-access memory (RAM), a magnetic disk storage medium, an optical storage medium, flash memory devices, electrical, optical, acoustic or other types of radio signals (for example, carrier waves, infrared signals, digital signals, or the like), and any other signals.

The controller 160 may control the vertical actuator 131 and the horizontal actuator 132 to drive the slit door 120 in the vertical direction and the first horizontal direction. Specifically, the controller 160 may control the vertical actuator 131 and the horizontal actuator 132 to drive the slit door 120 from a chamber sealing position to a chamber open position. In addition, the controller 160 may control the horizontal actuator 132 to drive the first scaling plate 121-1 and the second scaling plate 121-2 from an expansion position to a contraction position. An operation, performed by the controller 160, of controlling the slit door actuator 130 is described below in detail with reference to figures corresponding thereto.

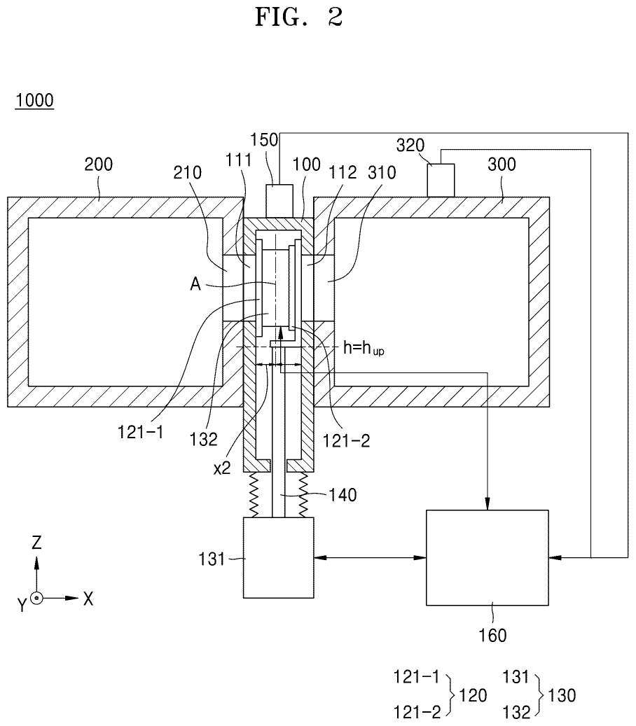

FIG. 2 is a cross-sectional view of the slit valve apparatus 1000 according to an implementation.

Referring to FIGS. 1 and 2, the slit door 120 may be arranged to be movable between the chamber open position and the chamber sealing position. Specifically, FIG. 1 is a cross-sectional view illustrating a situation in which the slit door 120 is at the chamber open position, and FIG. 2 is a cross-sectional view illustrating a situation in which the slit door 120 is at the chamber sealing position.

Herein, the chamber open position may refer to a position of the slit door 120 to allow a substrate to move from the transfer chamber 200 toward the processing chamber 300. In addition, the chamber sealing position may refer to a position of the slit door 120 to block a substrate from moving from the transfer chamber 200 toward the processing chamber 300 and moving from the processing chamber 300 toward the transfer chamber 200.

For example, the chamber open position may be a position of the slit door 120 to cause the first passage 111 and the second passage 112 to be opened. In addition, the chamber sealing position may be a position of the slit door 120 to cause the first passage 111 and the second passage 112 to be closed.

Referring again to FIG. 1, at the chamber open position, a vertical-direction position of the slit door 120 may be 0 (that is, h=0). Herein, for convenience of description, it is assumed that the vertical-direction position of the slit door 120 is determined based on a position of the lowermost portion of the slit door 120, as shown in FIGS. 1 and 2. In addition, at the chamber open position, each of the first sealing plate 121-1 and the second sealing plate 121-2 may be arranged to be apart from the central axis A of the housing 100 by as much as a first distance x1 in the first horizontal direction.

On the other hand, referring to FIG. 2, at the chamber sealing position, the vertical-direction position of the slit door 120 may be hᵤₚ (that is, h=hᵤₚ). In addition, at the chamber sealing position, each of the first sealing plate 121-1 and the second sealing plate 121-2 may be arranged to be apart from the central axis A of the housing 100 by as much as a second distance x2 in the first horizontal direction.

For example, when a substrate moves from the transfer chamber 200 to the processing chamber 300 or moves from the processing chamber 300 to the transfer chamber 200, the slit door 120 may move from the chamber sealing position to the chamber open position and then move again from the chamber open position to the chamber sealing position.

Specifically, when the slit door 120 moves from the chamber sealing position to the chamber open position, first, to contract the interval between the first sealing plate 121-1 and the central axis A from the second distance x2 to the first distance x1, the controller 160 may control the horizontal actuator 132 to drive the first sealing plate 121-1 and the second sealing plate 121-2 in the first horizontal direction. Next, to reduce the vertical height of the slit door 120 from hᵤₚ to 0, the controller 160 may control the vertical actuator 131 to drive the slit door 120 in the vertical direction.

In addition, when the slit door 120 moves from the chamber open position to the chamber sealing position, first, to increase the vertical height of the slit door 120 from 0 to hᵤₚ, the controller 160 may control the vertical actuator 131 to drive the slit door 120 in the vertical direction. Next, to expand the interval between the first sealing plate 121-1 and the central axis A from the first distance x1 to the second distance x2, the controller 160 may control the horizontal actuator 132 to drive the first sealing plate 121-1 and the second sealing plate 121-2 in the first horizontal direction.

In the following description, for convenience of description, when each of the first sealing plate 121-1 and the second sealing plate 121-2 is located apart from the central axis A by as much as the second distance x2, the first sealing plate 121-1 and the second sealing plate 121-2 are referred to as “being at an expansion position”. In addition, when each of the first sealing plate 121-1 and the second sealing plate 121-2 is located apart from the central axis A by as much as the first distance x1, the first sealing plate 121-1 and the second sealing plate 121-2 are referred to as “being at a contraction position”. In other words, the “expansion position” is a position of each of the first sealing plate 121-1 and the second sealing plate 121-2 to cause the first passage 111 and the second passage 112 to be closed, and the “contraction position” is a position of each of the first sealing plate 121-1 and the second sealing plate 121-2 to cause the first passage 111 and the second passage 112 to be opened.

As described above, when the slit door 120 is driven in the vertical direction or the first sealing plate 121-1 and the second scaling plate 121-2 are driven in the first horizontal direction, vibration (or a shock or jolt) may be applied to the processing chamber 300. Due to the vibration applied to the processing chamber 300, unnecessary particles may be generated in the processing chamber 300, or the durability of internal components of the processing chamber 300 may deteriorate.

According to the related art, to minimize such a shock described above, a user (for example, an engineer) has identified an appropriate driving velocity based on data or the like during a first operation, and then, has continued to drive the slit door 120 at the identified driving velocity. Alternatively, whenever a user has operated the slit valve apparatus 1000, the user has needed to set the driving velocity of the slit door 120. As such, when a user needs to directly control the driving velocity of the slit door 120, there may be an issue of not dealing with changes in semiconductor equipment over time.

For example, as time passes, external conditions, such as an ambient temperature and an ambient pressure, of the slit valve apparatus 1000 may change little by little, or fastening members, such as bolts and nuts, which make coupling states in the slit valve apparatus 1000 or the processing chamber 300, may be unfastened little by little. Due to such changes over time, the amount of vibration applied to the processing chamber 300 may change even when the slit door 120 is driven by the same displacement profile.

In each period in which the slit door 120 is driven, the controller 160 of the slit valve apparatus 1000 according to an implementation may identify the amount of vibration of the processing chamber 300 and may adaptively control the driving of the slit door 120 based on the identified amount of vibration. As the controller 160 adaptively controls the driving of the slit door 120, the slit valve apparatus 1000 may appropriately respond to changes thereof over time and may cause the amount of vibration of the processing chamber 300 not to exceed a target vibration value. An operation, performed by the controller 160, of adaptively controlling the slit door 120 is described below in detail with reference to figures corresponding thereto.

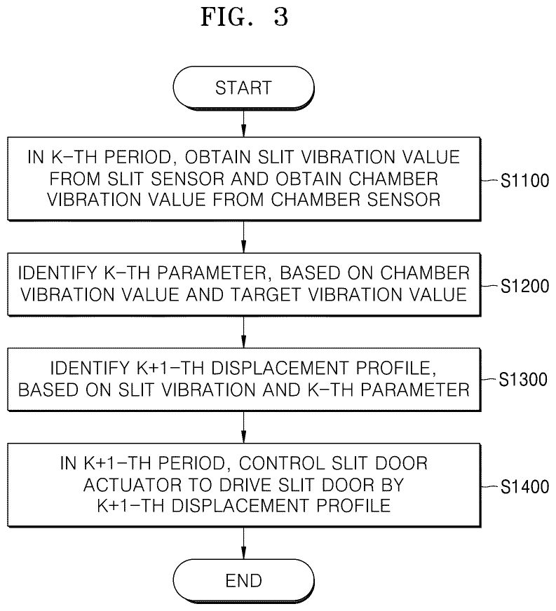

FIG. 3 is a flowchart illustrating a method S1000 of driving a slit door of the slit valve apparatus 1000, according to an implementation. Descriptions provided below with reference to FIGS. 3 to 9 are made by referring together to FIGS. 1 and 2.

Referring to FIG. 3, in a k-th period (where k is a natural number of 2 or more), the controller 160 may obtain a slit vibration value from the slit sensor 150 and obtain a chamber vibration value from the chamber sensor 320 (S1100, which is referred to as a “first operation”, hereinafter).

As used herein, the term “period” may refer to a time interval for which the controller 160 performs an operation of identifying a displacement profile of the slit door 120 by obtaining the slit vibration value and the chamber vibration value. The “period” may be determined based on various criteria.

As an example, “one period” may be a time interval for which the position of the slit door 120 changes in order of “chamber sealing position→chamber open position→chamber scaling position”. In this case, for the time interval for which the position of the slit door 120 changes in order of “chamber sealing position→chamber open position→chamber scaling position”, the controller 160 may obtain the slit vibration value sensed by the slit sensor 150 and the chamber vibration value sensed by the chamber sensor 320.

As another example, because the vibration applied to the processing chamber 300 may be generated in the greatest amount when the position of each of the first sealing plate 121-1 and the second sealing plate 121-2 changes from the contraction position to the expansion position, the “one period” may be a time interval for which the position of each of the first sealing plate 121-1 and the second sealing plate 121-2 changes in order of “contraction position→expansion position”. In this case, for the time interval for which the position of each of the first sealing plate 121-1 and the second sealing plate 121-2 changes in order of “contraction position→expansion position”, the controller 160 may obtain the slit vibration value sensed by the slit sensor 150 and the chamber vibration value sensed by the chamber sensor 320.

As yet another example, the “one period” may be a time interval for which the position of each of the first sealing plate 121-1 and the second sealing plate 121-2 changes in order of “expansion position→contraction position”, and as such, the period may be determined based on various criteria.

In addition, the term “slit vibration value” used herein may refer to a vibration value of the housing 100, which is sensed by the slit sensor 150. Furthermore, the term “chamber vibration value” used herein may refer to a vibration value of the processing chamber 300, which is sensed by the chamber sensor 320. For example, each of the slit vibration value and the chamber vibration value may include a vibration acceleration and may be measured in units of “mm/s²”.

Next, the controller 160 may identify a k-th parameter based on the chamber vibration value and a target vibration value (S1200, which is referred to as a “second operation”, hereinafter).

The k-th parameter may include a plurality of parameters used for a control operation in the k-th period. Here, the control operation in the k-th period may refer to a control operation performed by the controller 160 to receive the slit vibration value in the k-th period as an input and then output a k+1-th displacement profile. An algorithm required for the control operation may be stored in the controller 160. In addition, the k+1-th displacement profile may refer to a driving profile of the slit door 120 in a k+1-th period.

As used herein, the term “target vibration value” may refer to a chamber vibration value not causing an issue in the state of the processing chamber 300. For example, when the target vibration value is 750 mm/s², a shock applied to the processing chamber 300 is not quite great in the case where the chamber vibration value is 750 mm/s² or less, and no issue may be caused in the state of the processing chamber 300.

The target vibration value may be determined based on characteristics of the processing chamber 300. Here, the characteristics of the processing chamber 300 may include at least one of a material constituting the processing chamber 300, the size, shape, and structure of the processing chamber 300, and the type of semiconductor process performed in the processing chamber 300. Specifically, the target vibration value may be determined based on the type, ductility, or brittleness of the material constituting the processing chamber 300, or a coupling structure, arrangement structure, or the like of components constituting the processing chamber 300. The target vibration value may vary depending on a change in period. For example, the coupling strength or the like of the components constituting the processing chamber 300 may decrease over time, and thus, the target vibration value may decrease. In addition, the target vibration value may be preset by a user (for example, a process engineer).

In the second operation, the controller 160 may identify a k-th parameter by comparing the chamber vibration value in the k-th period with the target vibration value.

For example, the controller 160 may identify an error (e.g., a difference) between the chamber vibration value and the target vibration value and may identify, as the k-th parameter, a plurality of parameters minimizing the square of the error. In other words, the controller 160 may identify the k-th parameter based on the least square method (LSM).

However, the method of identifying the k-parameter based on the LSM described above is only an example. The controller 160 may also identify the k-parameter based on a method, such as the ridge regression method, the Lasso regression method, the maximum likelihood estimation (MLE) method, or the Newton-Raphson method.

In the k-th period, the chamber vibration value input to the controller 160 may include a vibration value generated based on the driving of the slit door 120 (e.g., a movement of the slit door 120), which corresponds to a k-th displacement profile, and a vibration value due to disturbance. Here, the k-th displacement profile is a displacement profile of the slit door 120, which is identified based on a control operation performed in a k−1-th period by the controller 160 by using a k−1-th parameter.

The vibration value due to disturbance may refer to vibration generated by an unpredicted change. The unpredicted change may include a change in a system over time, vibration generated from outside the system, or a change in an external condition (for example, an external temperature, an external pressure, or the like) of the system, or the like.

In an ideal case where there is no vibration value due to disturbance described above, the chamber vibration value may be consistent with the target vibration value. However, in the case of an actual system, there is bound to be a vibration value due to disturbance, and the vibration value due to disturbance may vary over time. Therefore, to compensate for the vibration value due to disturbance, which may vary over time, adaptive control may be required. For this purpose, the controller 160, in every period, may compare the chamber vibration value with the target vibration value and may identify an optimum parameter capable of compensating for the vibration value due to disturbance, based on a result of the comparing.

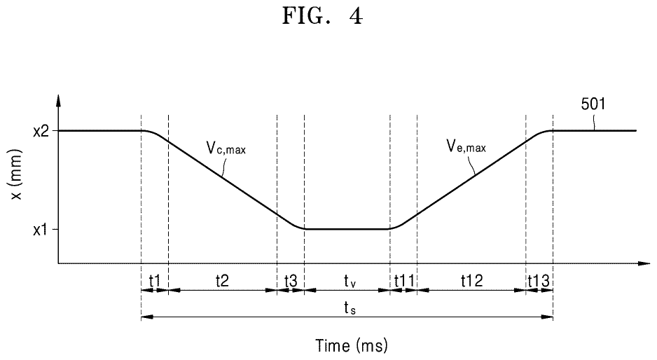

Next, the controller 160 may identify the k+1-th displacement profile based on the slit vibration value and the k-th parameter (S1300, which is referred to as a “third operation”, hereinafter). Here, the k+1-th displacement profile identified in the third operation may be a driving profile of the slit door 120 in the k+1-th period. The k+1-th displacement profile may include vertical-direction displacement information of the slit door 120 and first-horizontal-direction displacement information of each of the first sealing plate 121-1 and the second sealing plate 121-2, in the k+1-th period. This is described below in detail with reference to FIGS. 4 to 6.

Next, in the k+1-th period, the controller 160 may control the slit door actuator 130 to drive the slit door 120 by the k+1-th displacement profile (S1400, which is referred to as a “fourth operation”, hereinafter).

As described above, by driving the slit door 120 according to the first to fourth operations, the controller 160 may quickly open and close the first passage 111 and the second passage 112 even while minimizing the amount of vibration applied to the processing chamber 300.

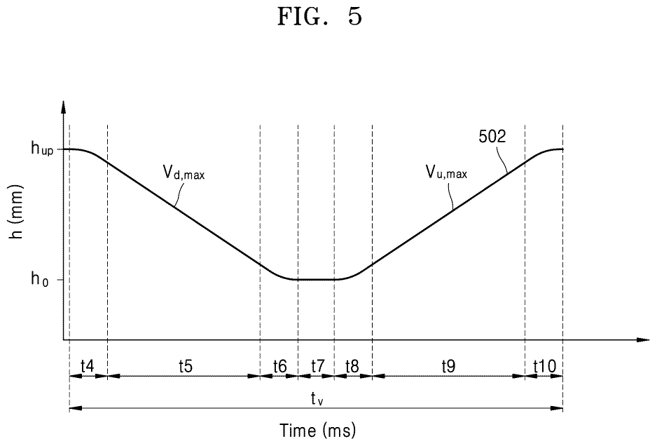

FIG. 4 is a graph schematically illustrating a horizontal-direction displacement profile of a sealing plate, according to an implementation. FIG. 5 is a graph schematically illustrating a vertical-direction displacement profile of a slit door, according to an implementation.

The following descriptions are made under the assumption that “one period” is a time interval for which the slit door 120 moves in order of “chamber sealing position→chamber open position→chamber sealing position”.

Referring to FIGS. 4 and 5, one period may be a slit time interval tₛ. The slit time interval tₛ may include first to thirteenth sections t1 to t13. Here, the first to sixth sections t1 to t6 may be an open section in which the position of the slit door 120 changes from the chamber scaling position to the chamber open position. In addition, the eighth to thirteenth sections t8 to t13 may be a sealing section in which the position of the slit door 120 changes from the chamber open position to the chamber sealing position.

Furthermore, in the first to third sections t1, t2, and t3 and the eleventh to thirteenth sections t11, t12, and t13, the horizontal actuator 132 may drive the first sealing plate 121-1 and the second scaling plate 121-2 in the first horizontal direction, and in the fourth to tenth sections t4 to t10, the vertical actuator 131 may drive the slit door 120 in the vertical direction.

The graph shown in FIG. 4 is a first-horizontal-direction displacement profile graph 501 of each of the first sealing plate 121-1 and the second sealing plate 121-2. Specifically, the Y value of the first-horizontal-direction displacement profile graph 501 represents a distance in the first horizontal direction between the first sealing plate 121-1 and the central axis A (or a distance in the first horizontal direction between the second sealing plate 121-2 and the central axis A), and the X value of the first-horizontal-direction displacement profile graph 501 represents time.

The graph shown in FIG. 5 is a vertical-direction displacement profile graph 502 of the slit door 120. Specifically, the Y value of the vertical-direction displacement profile graph 502 represents a vertical-direction position of the slit door 120, and the X value of the vertical-direction displacement profile graph 502 represents time.

Referring to FIG. 4, in the k-th period, the horizontal actuator 132 may drive the first sealing plate 121-1 and the second sealing plate 121-2, based on first-horizontal-direction displacement information in the k-th period. Here, the first-horizontal-direction displacement information may include at least one of horizontal-direction target point information, horizontal-direction maximum velocity information, and horizontal-direction acceleration information.

For example, the horizontal-direction target point information may include a “first distance x1 between the central axis A and the first sealing plate 121-1 at the contraction position (or a first distance x1 between the central axis A and the second sealing plate 121-2 at the contraction position)” and a “second distance x2 between the central axis A and the second sealing plate 121-2 at the expansion position (or a second distance x2 between the central axis A and the second sealing plate 121-2 at the expansion position)”.

The horizontal-direction maximum velocity information may include a maximum velocity V_{c,max} of each of the first sealing plate 121-1 and the second sealing plate 121-2 upon the contraction thereof and a maximum velocity V_{e,max} of each of the first sealing plate 121-1 and the second sealing plate 121-2 upon the expansion thereof. Here, the contraction of each of the first scaling plate 121-1 and the second sealing plate 121-2 may mean that the position of each of the first sealing plate 121-1 and the second sealing plate 121-2 changes from the “expansion position” to the “contraction position”. In addition, the expansion of each of the first sealing plate 121-1 and the second sealing plate 121-2 may mean that the position of each of the first sealing plate 121-1 and the second sealing plate 121-2 changes from the “contraction position” to the “expansion position”.

The horizontal-direction acceleration information may include information about driving each of the first sealing plate 121-1 and the second sealing plate 121-2 to be accelerated to a horizontal-direction maximum velocity or to be decelerated from the horizontal-direction maximum velocity to a stopped state. For example, as shown in FIG. 4, in the first section t1, the first sealing plate 121-1 may be accelerated from the stopped state to the maximum velocity V_{c,max} upon the contraction thereof, and in the third section t3, the first sealing plate 121-1 may be decelerated from the maximum velocity V_{e,max} upon the expansion thereof to the stopped state. The horizontal-direction acceleration information may include an acceleration in the first section t1, an acceleration in the third section t3, an acceleration in the eleventh section t11, and an acceleration in the thirteenth section t13.

Referring to FIG. 5, in the k-th period, the vertical actuator 131 may drive the slit door 120 based on vertical-direction displacement information in the k-th period. Here, the vertical-direction displacement information may include at least one of vertical-direction target point information, vertical-direction maximum velocity information, and vertical-direction acceleration information.

For example, the vertical-direction target point information may include a “vertical-direction minimum height h₀ of the slit door 120 at the chamber open position” and a “vertical-direction maximum height hᵤₚ of the slit door 120 at the chamber sealing position”.

The vertical-direction maximum velocity information may include a maximum velocity V_{d,max} of the slit door 120 upon the downward movement thereof and a maximum velocity V_{u,max} of the slit door 120 upon the upward movement thereof. Here, the downward movement of the slit door 120 may refer to a movement of the slit door 120 when the slit door 120 moves from the vertical level thereof at the chamber sealing position to the vertical level thereof at the chamber open position, and the upward movement of the slit door 120 may refer to a movement of the slit door 120 when the slit door 120 moves from the vertical level thereof at the chamber open position to the vertical level thereof at the chamber sealing position.

The vertical-direction acceleration information may include information about driving the slit door 120 to be accelerated to a vertical-direction maximum velocity or to be decelerated from the vertical-direction maximum velocity to a stopped state. For example, as shown in FIG. 5, in the fourth section t4, the slit door 120 may be accelerated from the stopped state to the maximum velocity V_{d,max} upon the downward movement thereof, and in the sixth section t6, the slit door 120 may be decelerated from the maximum velocity V_{d,max} upon the downward movement thereof to the stopped state. The vertical-direction acceleration information may include an acceleration in the fourth section t4, an acceleration in the sixth section t6, an acceleration in the eighth section t8, and an acceleration in the tenth section t10.

In the third operation, the controller 160 may identify the k+1-th displacement profile based on the slit vibration value and the k-th parameter. The controller 160 may receive the slit vibration value as an input and may identify the k+1-th displacement profile based on a control operation for outputting a displacement profile. Here, the control operation may include an operation process using the k-th parameter.

According to an implementation, the control operation performed by the controller 160 by using the k-th parameter may output the k+1-th displacement profile having a reduced vertical-direction maximum velocity and/or a reduced horizontal-direction maximum velocity as compared with the k-th displacement profile, when the slit vibration value is large.

According to an implementation, the control operation performed by the controller 160 by using the k-th parameter may output the k+1-th displacement profile having an increased vertical-direction maximum velocity and/or an increased horizontal-direction maximum velocity as compared with the k-th displacement profile, when the slit vibration value is small.

According to an implementation, the control operation performed by the controller 160 by using the k-th parameter may output the k+1-th displacement profile having a reduced vertical-direction acceleration and/or a reduced horizontal-direction acceleration as compared with the k-th displacement profile, when the slit vibration value is large.

According to an implementation, the control operation performed by the controller 160 by using the k-th parameter may output the k+1-th displacement profile having an increased vertical-direction acceleration and/or an increased horizontal-direction acceleration as compared with the k-th displacement profile, when the slit vibration value is small.

According to another implementation, due to an error of a vertical-direction position sensor arranged adjacent to the slit door 120, there may be a situation in which there is a difference between a vertical-direction position of the slit door 120 sensed by the vertical-direction position sensor and an actual vertical-direction position of the slit door 120, or there may be a situation in which the slit door 120 collides with an upper portion of the housing 100. In this case, the control operation performed by the controller 160 by using the k-th parameter may output the k+1-th displacement profile having a relatively reduced vertical-direction maximum height hᵤₚ and a relatively reduced vertical-direction minimum height h₀ as compared with the k-th displacement profile.

According to another implementation, due to an error of a horizontal-direction position sensor arranged adjacent to the first sealing plate 121-1, the second sealing plate 121-2, and the horizontal actuator 132, the first distance x1 and the second distance x2, which are sensed by the horizontal-direction position sensor, may not be respectively consistent with the actual first distance x1 and the actual second distance x2, or there may be a situation in which the first and second sealing plates 121-1 and 121-2 respectively collide hard with a sidewall on a first passage 111 side and a sidewall on a second passage 112 side. In this case, the control operation performed by the controller 160 by using the k-th parameter may output the k+1-th displacement profile having a relatively reduced first distance x1 and a relatively reduced second distance x2 as compared with the k-th displacement profile.

In the above description, although it is described that the k+1-th displacement profile may be output by adjusting the maximum velocity, the acceleration, and the target point position in the vertical direction or the horizontal direction, this is only an example provided for convenience of description. It is a matter of course that the control operation by the controller 160 according to an implementation may output the k+1-th displacement profile by adjusting at least one of the maximum velocity, the acceleration, and the target point position in the vertical direction or the horizontal direction.

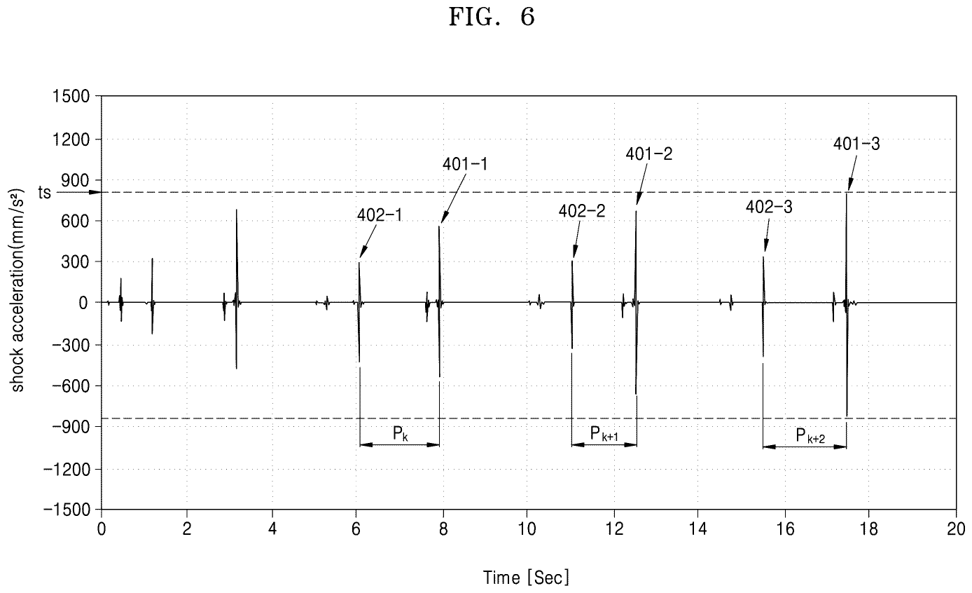

As described above, by increasing or decreasing at least one of the maximum velocity, the acceleration, and the target point position in the vertical direction or the horizontal direction, the controller 160 may control the driving of the slit door 120 for the chamber vibration value of the processing chamber 300 to converge on the target vibration value. In the following description made with reference to FIG. 6, vibration values according to the driving of the slit door 120 are described in detail.

FIG. 6 is a graph schematically illustrating chamber vibration values according to the driving of the slit door 120, according to an implementation.

In the graph of FIG. 6, which illustrates chamber vibration values according to the driving of the slit door 120, the X axis represents time, and the Y axis represents vibration acceleration.

Referring to FIG. 6, a first sealing peak 401-1, a second sealing peak 401-2, and a third scaling peak 401-3 may be observed in the graph. In addition, a first open peak 402-1, a second open peak 402-2, and a third open peak 402-3 may be observed in the graph. Furthermore, the straight lines respectively indicated by y=850 (mm/s²) and y=−850 (mm/s²) in the graph may each be a target vibration value straight line ts.

Here, the first to third sealing peaks 401-1, 401-2, and 401-3 may each indicate a peak of the chamber vibration value generated when the position of a sealing plate changes from the contraction position to the expansion position. In addition, the first to third open peaks 402-1, 402-2, and 402-3 may each indicate a peak of the chamber vibration value generated when the position of the sealing plate changes from the expansion position to the contraction position. In this case, the chamber vibration value in the k-th period may include a vibration value generated based on the driving of the sealing plate and a vibration value due to disturbance.

In other words, the chamber vibration value may be larger due to the first-horizontal-direction movement of the sealing plate rather than due to the vertical-direction movement of the slit door 120. Therefore, it may be significant to appropriately set a first-horizontal-direction displacement profile of the sealing plate.

Referring to FIG. 6, in a k-th period Pₖ, the chamber sensor 320 may sense the first open peak 402-1 and the first sealing peak 401-1. The controller 160 may identify a k-th parameter in the k-th period Pₖ, based on the respective values of the first open peak 402-1 and the first sealing peak 401-1 and on the target vibration value. The k-th parameter may include a plurality of parameters used for a control operation for outputting a displacement profile upon the contraction of the sealing plate and a plurality of parameters used for a control operation for outputting a displacement profile upon the expansion of the scaling plate.

Specifically, the controller 160 may identify a first open error between the value of the first open peak 402-1 and the target vibration value by comparing the value of the first open peak 402-1 with the target vibration value and may identify a plurality of parameters minimizing the first open error. In addition, the controller 160 may identify a first sealing error between the value of the first sealing peak 401-1 and the target vibration value by comparing the value of the first sealing peak 401-1 with the target vibration value and may identify a plurality of parameters minimizing the first sealing error. The controller 160 may identify, as the k-th parameter, the plurality of parameters minimizing the first open error and the plurality of parameters minimizing the first sealing error.

In the k-th period Pₖ, the controller 160 may identify the k+1-th displacement profile by inputting the slit vibration value, which is obtained from the slit sensor 150, to the control operation based on the k-th parameter. Next, in a k+1-th period Pₖ₊₁, the controller 160 may control the horizontal actuator 132 to drive the first sealing plate 121-1 and the second sealing plate 121-2 by the k+1-th displacement profile. Even in the k+1-th period Pₖ₊₁, it is a matter of course that the chamber sensor 320 may also sense the second open peak 402-2 and the second sealing peak 401-2 and the controller 160 may also identify a k+1-th parameter based on the respective values of the second open peak 402-2 and the second sealing peak 401-2 that are sensed and on the target vibration value.

As shown in FIG. 6, through the control described above, the slit valve apparatus 1000 according to an implementation may cause a peak value of the chamber vibration value to be between two target vibration value straight lines ts. In addition, through the control described above, the slit valve apparatus 1000 may achieve an effect of allowing the chamber vibration value to gradually converge on the target vibration value whenever the period changes even while causing the chamber vibration value not to exceed the target vibration value.

In the above description made with reference to FIG. 6, although it is described that the chamber vibration value may have a peak when the position of the sealing plate is the expansion position or the contraction position, this is only an example. The chamber vibration value may have a peak due to a change in semiconductor equipment over time, an external factor, and the like even in a situation of the upward movement of the slit door 120, a situation of the downward movement of the slit door 120, or the like, and the controller 160 according to an implementation may identify a movement situation in which a vibration peak is generated, based on the time at which the peak of the chamber vibration value is generated, and may update a parameter corresponding to the movement situation.

For example, referring again to FIG. 5, when it is identified that a section in which the vibration peak has been generated is fourth to sixth sections t4, t5, and t6, the controller 160 may identify that the vibration peak has been generated in the situation of the downward movement of the slit door 120. In this case, the controller 160 may update the plurality of parameters used for the control operation for outputting the displacement profile that includes the maximum velocity V_{d,max}, the vertical-direction minimum height h₀, and the like upon the downward movement of the slit door 120.

As another example, when it is identified that the section in which the vibration peak has been generated is eighth to tenth sections t8, 19, and t10, the controller 160 may identify that the vibration peak has been generated in the situation of the upward movement of the slit door 120. In this case, the controller 160 may update the plurality of parameters used for the control operation for outputting the displacement profile that includes the maximum velocity V_{u,max}, the vertical-direction maximum height hᵤₚ, and the like upon the upward movement of the slit door 120.

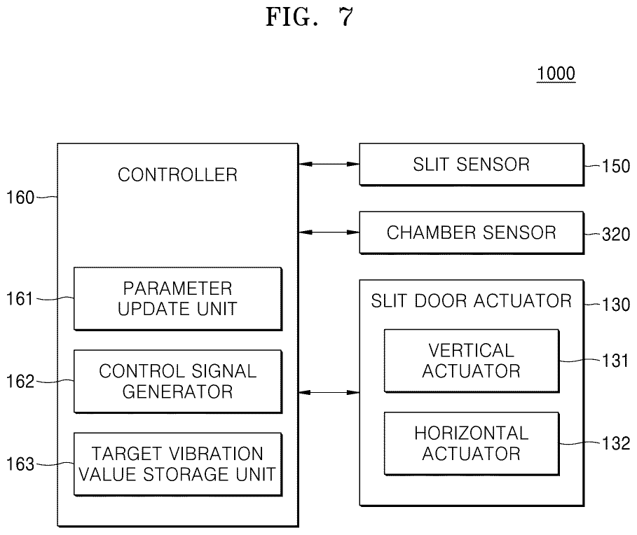

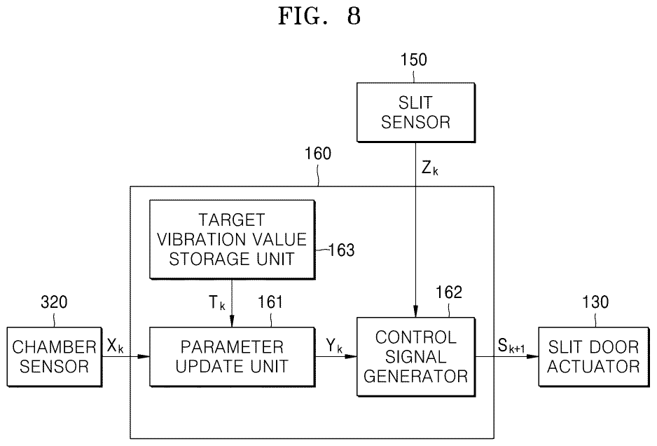

In the following description made with reference to FIGS. 7 and 8, a control operation by the controller 160 is described in detail by dividing the control operation into operations on a function basis.

FIG. 7 is a block diagram schematically illustrating a configuration of the slit valve apparatus 1000 according to an implementation. FIG. 8 is a block diagram schematically illustrating operations of the slit valve apparatus 1000 according to an implementation.

The controller 160 may include a parameter update unit 161, a control signal generator 162, and a target vibration value storage unit 163. The controller 160 may be operationally connected to each of the slit sensor 150, the chamber sensor 320, and the slit door actuator 130.

Referring to FIG. 8, in the k-th period, the parameter update unit 161 may obtain a chamber vibration value Xₖ from the chamber sensor 320 and may obtain a target vibration value Tₖ from the target vibration value storage unit 163. The parameter update unit 161 may identify a k-th parameter Yₖ based on the chamber vibration value Xₖ and the target vibration value Tₖ.

For example, the parameter update unit 161 may identify, as the k-th parameter Yₖ, a plurality of parameters minimizing an error between the chamber vibration value Xₖ and the target vibration value Tₖ. Here, a method of identifying the k-th parameter Yₖ based on the chamber vibration value Xₖ and the target vibration value Tₖ may be implemented by a method, such as the LSM, the ridge regression method, the Lasso regression method, the MLE method, or the Newton-Raphson method. In addition, as shown in FIG. 6, the chamber vibration value Xₖ may include a plurality of vibration peak values sensed by the chamber sensor 320 in one period.

The target vibration value storage unit 163 may store the target vibration value Tₖ of the processing chamber 300. Because the target vibration value Tₖ is determined based on the characteristics of the processing chamber 300, the target vibration value Tₖ may be constant or may vary depending on a change in period. For example, the target vibration value Tₖ may vary due to the deterioration in the material constituting the processing chamber 300, a change in the type of semiconductor process performed in the processing chamber 300, or the like.

The control signal generator 162 may obtain a slit vibration value Zₖ from the slit sensor 150 and may obtain the k-th parameter Yₖ from the parameter update unit 161. The control signal generator 162 may obtain a k+1-th displacement profile Sₖ₊₁ by inputting the slit vibration value Zₖ to a control operation that is based on the k-th parameter Yₖ. Next, in the k+1-th period, the control signal generator 162 may control the slit door actuator 130 to drive the slit door 120 and a sealing plate by the k+1-th displacement profile Sₖ₊₁.

In FIGS. 7 and 8, although the controller 160 is illustrated as being divided into the parameter update unit 161, the control signal generator 162, and the target vibration value storage unit 163 to describe an operation of the controller 160 in detail for each stage, this is only for convenience of description. The parameter update unit 161, the control signal generator 162, and the target vibration value storage unit 163 are respectively functional components constituting one algorithm and may respectively refer to modularized functional components.

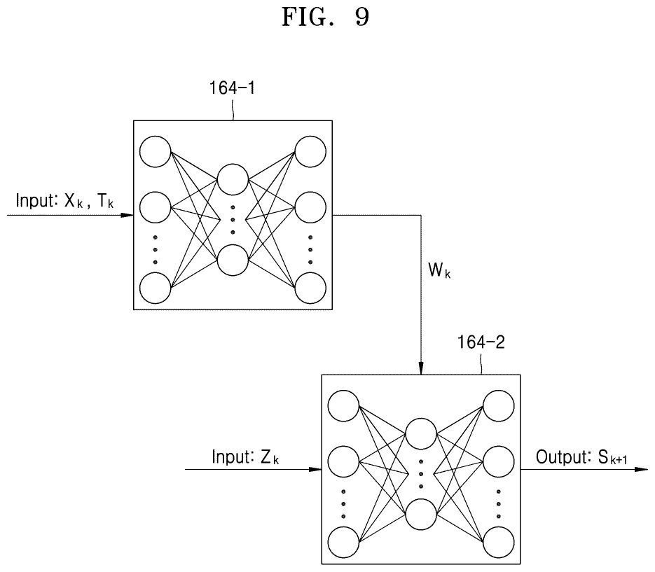

Operations, performed by the controller 160, of updating a parameter and generating a control signal operation may be performed based on an artificial neural network model. This is described in detail in the following description made with reference to FIG. 9.

FIG. 9 is a conceptual diagram illustrating an artificial neural network model according to an implementation.

The controller 160 may further include a memory storing an artificial neural network model, and the artificial neural network model may include an artificial neural network model trained to receive the slit vibration value Zₖ, the chamber vibration value Xₖ, and the target vibration value Tₖ as inputs and to output the k+1-th displacement profile Sₖ₊₁.

According to an implementation, the artificial neural network model may include a first neural network model 164-1 and a second neural network model 164-2. Specifically, the first neural network model 164-1 may comprise a network trained to receive the chamber vibration value Xₖ and the target vibration value Tₖ as inputs and to output a plurality of weights Wₖ, which are updated, of the second neural network model 164-2. The second neural network model 164-2 may comprise a network trained to receive the slit vibration value Zₖ as an input and to output the k+1-th displacement profile Sₖ₊₁.

Specifically, the first neural network model 164-1 may output a weight Wₖ in the k-th period, the weight Wₖ minimizing an error between the chamber vibration value Xₖ and the target vibration value Tₖ. Here, the chamber vibration value Xₖ may include a vibration value generated based on the driving of the slit door 120, which corresponds to a k-th displacement profile Sₖ, and a vibration value due to disturbance. In addition, the k-th displacement profile Sₖ may be a displacement profile output by the second neural network model 164-2, based on a weight Wₖ₋₁ in the k−1-th period. When the second neural network model 164-2 is represented by a function of f(Z, W) and vibration generated based on the driving of the slit door 120 is represented by a function of g(S), the chamber vibration value Xₖ may be represented by Equation 1 shown below.

$${X}_{k} = g ( f ( {Z}_{k - 1} , {W}_{k - 1} ) ) + {D}_{k} , {S}_{k} = f ( {Z}_{k - 1} , {W}_{k - 1} ) \qquad [ Equation 1 ]$$

Here, Zₖ₋₁ may refer to a slit vibration value in the k−1-th period, Wₖ₋₁ may refer to a weight of the second neural network model 164-2 in the k−1-th period, and Dk may refer to a vibration value due to disturbance in the k-th period.

Here, the function f(Z, W) is a function representing an operation of the second neural network model 164-2, which receives a slit vibration value (that is, Z) and a weight (that is, W) as inputs and outputs a displacement profile (that is, S). In addition, the function g(S) is a function predicting a chamber vibration value applied to the processing chamber 300 when the slit door 120 is driven by the displacement profile (that is, S).

According to an implementation, the first neural network model 164-1 may identify the weight Wₖ in the k-th period, the weight Wₖ minimizing the error between the chamber vibration value Xₖ and the target vibration value Tₖ.

$${W}_{k} = arg {min}_{{W}_{k - 1}} \{ {( {X}_{k} - {T}_{k} )}^{2} \} = arg {min}_{{W}_{k - 1}} \{ {( g ( f ( {Z}_{k - 1} , {W}_{k - 1} ) ) + {D}_{k} - {T}_{k} )}^{2} \} \qquad [ Equation 2 ]$$

The first neural network model 164-1 may identify a weight minimizing the error between the chamber vibration value Xₖ and the target vibration value Tₖ and may identify the identified weight as the weight Wₖ in the k-th period. Specifically, the first neural network model 164-1 may iterate a process of calculating the error between the chamber vibration value Xₖ and the target vibration value Tₖ while making a slight change in the weight Wₖ₋₁ in the k−1-th period. In such an iteration process, a weight (that is, W), which minimizes the error between the chamber vibration value Xₖ and the target vibration value Tₖ, may be identified, and the identified weight may be identified as the weight Wₖ in the k-th period.

The first neural network model 164-1 may provide the weight Wₖ in the k-th period to the second neural network model 164-2. The second neural network model 164-2 may receive a slit vibration value Zₖ as an input and may output a k+1-th displacement profile Sₖ₊₁ through an operation using the weight Wₖ in the k-th period.

In other words, the first neural network model 164-1 may identify the weight Wₖ, which minimizes the aforementioned error, in the k-th period while making a slight change in the weight Wₖ₋₁ in the k−1-th period. Therefore, the first neural network model 164-1 may provide, to the second neural network model 164-2, a new weight, which is based on an existing weight but able to reflect characteristics of a system undergoing changes better, rather than provide a completely newly trained weight every period to the second neural network model 164-2.

The second neural network model 164-2 may output a displacement profile in the next period based on a plurality of weights (that is, W) that are updated based on the chamber vibration value Xₖ and the target vibration value Tₖ every period. Therefore, the plurality of weights (that is, W) of the second neural network model 164-2 may be adaptively updated in response to a change in equipment over time and/or a change in an external factor, and the second neural network model 164-2 may output a more appropriate displacement profile of the slit door 120 by using the plurality of weights (that is, W) adaptively updated.

In FIG. 9 and the descriptions made with reference thereto, although it is illustrated and described that the first neural network model 164-1 for updating a weight and the second neural network model 164-2 for outputting a displacement profile are respectively separate components, this is only an example. A network for updating a weight and a network for outputting a displacement profile through an operation based on a weight may also be implemented as one artificial neural network model.

As described above, the slit valve apparatus 1000 according to an implementation may achieve an effect of quickly opening and closing the first passage 111 and the second passage 112 via the slit door 120 even while reducing a shock to the processing chamber 300 due to the driving of the slit door 120.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A slit valve apparatus comprising:
a housing between a first transfer port of a transfer chamber and a second transfer port of a processing chamber;
first and second passages corresponding to positions of the first and second transfer ports, respectively, each of the first and second passages extending from an outer surface of a sidewall of the housing to an inner surface of the sidewall of the housing;
a slit door in the housing, the slit door being configured to be move between a chamber open position and a chamber sealing position, wherein the slit door allows the first and second passages to be opened in the chamber open position and to be closed in the chamber sealing position;
a slit door actuator configured to drive the slit door in a vertical direction and a horizontal direction;
a slit sensor connected to the housing, the slit sensor being configured to sense vibration of the housing; and
a controller configured to control the slit door actuator,
wherein the controller is configured to:
in a k-th period, obtain a slit vibration value from the slit sensor, where k is a natural number of 2 or more;
identify, based on the slit vibration value and a k-th parameter, a k+1-th displacement profile; and
in a k+1-th period, control the slit door actuator to drive the slit door based on the k+1-th displacement profile,
wherein the k-th parameter includes at least one parameter associated with a control operation, the control operation comprising receiving the slit vibration value in the k-th period and outputting the k+1-th displacement profile.

2. The slit valve apparatus of claim 1, comprising a chamber sensor connected to the processing chamber, the chamber sensor being configured to sense vibration of the processing chamber,
wherein the controller is configured to:
in the k-th period, obtain a chamber vibration value from the chamber sensor; and
identify, based on the chamber vibration value and a target vibration value, the k-th parameter,
wherein the target vibration value is based on characteristics of the processing chamber, and
wherein the characteristics of the processing chamber comprise at least one of a material of the processing chamber, a size of the processing chamber, a shape of the processing chamber, a structure of the processing chamber, or a type of a semiconductor process performed in the processing chamber.

3. The slit valve apparatus of claim 2, wherein the chamber vibration value in the k-th period comprises a first vibration value based on a movement of the slit door and a second vibration value based on disturbance, the movement of the slit door being corresponding to a k-th displacement profile, and
wherein the control operation is a first control operation, and the controller is configured to identify the k-th displacement profile based on a second control operation that uses a k−1-th parameter in a k−1-th period.

4. The slit valve apparatus of claim 2, wherein the controller is configured to:
in the k-th period, identify an error between the chamber vibration value and the target vibration value; and
identify, as the k-th parameter, the at least one parameter for minimizing a square of the error.

5. The slit valve apparatus of claim 1, wherein each of the k-th period and the k+1-th period comprises an open section and a sealing section,
the open section includes a position of the slit door changing from the chamber sealing position to the chamber open position, and
the sealing section includes the position of the slit door changing from the chamber open position to the chamber sealing position.

6. The slit valve apparatus of claim 1, wherein the slit door comprises a sealing plate configured to open or close each of the first and second passages,
wherein the slit door actuator comprises a vertical actuator configured to drive the slit door in the vertical direction and a horizontal actuator configured to drive the sealing plate in the horizontal direction, and
wherein the k+1-th displacement profile comprises vertical-direction displacement information of the slit door and first-horizontal-direction displacement information of the sealing plate.

7. The slit valve apparatus of claim 6, wherein the vertical-direction displacement information of the slit door comprises at least one of vertical-direction target point information, vertical-direction maximum velocity information, or vertical-direction acceleration information of the slit door.

8. The slit valve apparatus of claim 6, wherein the first-horizontal-direction displacement information of the sealing plate comprises horizontal-direction target point information, horizontal-direction maximum velocity information, or horizontal-direction acceleration information of the sealing plate.

9. The slit valve apparatus of claim 2, wherein the controller comprises a memory configured to store an artificial neural network model, the artificial neural network model being configured to receive the slit vibration value in the k-th period as an input and output the k+1-th displacement profile, and
wherein the k-th parameter comprises a plurality of weights of the artificial neural network model in the k-th period.

10. The slit valve apparatus of claim 9, wherein the controller is configured to, in the k-th period, update the plurality of weights of the artificial neural network model based on the chamber vibration value and the target vibration value, and
wherein the controller is configured to minimize an error between the chamber vibration value and the target vibration value by updating the plurality of weights.

11. The slit valve apparatus of claim 2, wherein each of the slit sensor and the chamber sensor comprises at least one of an acceleration sensor, an angular velocity sensor, a velocity sensor, or a displacement sensor.

12. A slit valve apparatus comprising:
a housing between a first transfer port of a transfer chamber and a second transfer port of a processing chamber;
first and second passages arranged at positions respectively corresponding to positions of the first and second transfer ports, each of the first and second passages extending from an outer surface of a sidewall of the housing to an inner surface of the sidewall of the housing;
a sealing plate between the first and second passages;
a horizontal actuator configured to drive the sealing plate in a horizontal direction between an expansion position and a contraction position, wherein the sealing plate allows the first and second passages to be opened in the contraction position and to be closed in the expansion position;
a slit sensor connected to the housing, the slit sensor being configured to sense vibration of the housing; and
a controller configured to control the horizontal actuator,
wherein the controller is configured to:
in a k-th period, obtain a slit vibration value from the slit sensor, wherein k is a natural number of 2 or more;
identify, based on the slit vibration value and a k-th parameter, a k+1-th displacement profile; and
in a k+1-th period, control the horizontal actuator to drive the sealing plate based on the k+1-th displacement profile,
the k-th parameter includes at least one parameter associated with a control operation, the control operation comprising receiving the slit vibration value in the k-th period as an input and outputting the k+1-th displacement profile.

13. The slit valve apparatus of claim 12, comprising:
a chamber sensor connected to the processing chamber, the chamber sensor being configured to sense vibration of the processing chamber,
wherein the controller is configured to:
in the k-th period, obtain a chamber vibration value from the chamber sensor; and
identify, based on the chamber vibration value and a target vibration value. the k-th parameter,
wherein the target vibration value is based on characteristics of the processing chamber, and
wherein the characteristics of the processing chamber comprise at least one of a material of the processing chamber, a size of the processing chamber, a shape of the processing chamber, a structure of the processing chamber, or a type of a semiconductor process performed in the processing chamber.

14. The slit valve apparatus of claim 13, wherein the chamber vibration value in the k-th period comprises a first vibration value based on a movement of the sealing plate and a second vibration value based on disturbance, the movement of the sealing plate being corresponding to a k-th displacement profile, and
wherein the control operation is a first control operation, and the controller is configured to identify the k-th displacement profile based on a second control operation that uses a k−1-th parameter in a k−1-th period.

15. The slit valve apparatus of claim 13, wherein the controller is configured to:
in the k-th period, identify an error between the chamber vibration value and the target vibration value; and
identify, as the k-th parameter, the at least one parameter for minimizing a square of the error.

16. The slit valve apparatus of claim 12, wherein the k+1-th displacement profile comprises first-horizontal-direction displacement information of the sealing plate, and
wherein the first-horizontal-direction displacement information of the sealing plate comprises at least one of horizontal-direction target point information, horizontal-direction maximum velocity information, or horizontal-direction acceleration information of the sealing plate.

17. The slit valve apparatus of claim 13, wherein the controller comprises a memory configured to store an artificial neural network model, the artificial neural network model being configured to receive the slit vibration value in the k-th period as an input and output the k+1-th displacement profile, and
wherein the k-th parameter comprises a plurality of weights of the artificial neural network model in the k-th period.

18. The slit valve apparatus of claim 17, wherein the controller is configured to, in the k-th period, update the plurality of weights of the artificial neural network model based on the chamber vibration value and the target vibration value, and
wherein the controller is configured to minimize an error between the chamber vibration value and the target vibration value by updating the plurality of weights.

19. A slit valve apparatus comprising:
a housing between a first transfer port of a transfer chamber and a second transfer port of a processing chamber;
first and second passages respectively connected to the first and second transfer ports, each of the first and second passages extending from an outer surface of a sidewall of the housing to an inner surface of the sidewall of the housing;
a slit door in the housing, the slit door being configured to be move between a chamber open position and a chamber sealing position, wherein the slit door allows the first and second passages to be opened in the chamber open position and to be closed in the chamber sealing position;
a slit door actuator configured to drive the slit door in a vertical direction and a horizontal direction;
a slit sensor connected to the housing, the slit sensor being configured to sense vibration of the housing;
a chamber sensor connected to the processing chamber, the chamber sensor being configured to sense vibration of the processing chamber; and
a controller configured to control the slit door actuator,
wherein the controller is configured to:
in a k-th period, obtain a slit vibration value from the slit sensor and obtain a chamber vibration value from the chamber sensor, wherein k is a natural number of 2 or more;
identify, based on the chamber vibration value and a target vibration value, a k-th parameter, the target vibration value being based on characteristics of the processing chamber;
identify, based on the slit vibration value and the k-th parameter, a k+1-th displacement profile; and
in a k+1-th period, control the slit door actuator to drive the slit door based on the k+1-th displacement profile,
wherein the k-th parameter comprises at least one parameter associated with a control operation, the control operation comprising receiving the slit vibration value in the k-th period as an input and outputting the k+1-th displacement profile.

20. The slit valve apparatus of claim 19, wherein the characteristics of the processing chamber comprise at least one of a material of the processing chamber, a size of the processing chamber, a shape of the processing chamber, a structure of the processing chamber, or a type of a semiconductor process performed in the processing chamber.
